(19) United States
(12) Patent Application Publication
(10) Pub. No.: US 2010/0050506 A1
(43) Pub. Date: Mar. 4, 2010

(54) Watering Method and System for Soil Comprising Hydrogel

(75) Inventor: Aloys Hüttermann, Gottingen (DE)

Correspondence Address: MARSHALL, GERSTEIN & BORUN LLP, 233 SOUTH WACKER DRIVE, 6300 SEARS TOWER, CHICAGO, IL, 60606-6357, US

(73) Assignee: BASE SE a German Corporation, Ludwlgshafen (DE)

(21) Appl. No.: 12/516,288

(22) PCT Filed: Dec. 3, 2007
(86) PCT No.: PCT/EP2007/063126

§ 371 Date: May 26, 2009

(30) Foreign Application Priority Data
Dec. 7, 2006 (DE) 10 2006 058 065.6

(51) Int. Cl. A01G 25/00

(52) U.S. Cl. 47/48.5

(57) ABSTRACT

The present invention relates to the controlled irrigation of hydrogel-containing soils.

The present invention relates to the field of irrigation systems and methods, especially of irrigation systems and methods which are used in hydrogel-containing soils.

The use of hydrogels in soils has been prior art for some time. In this context, reference is made, inter alia, to DE 198 13 425 A1 and U.S. Pat. No. 6,484,441 B1, which are hereby incorporated by citation.

Some advantageous properties of hydrogels which cause them to be of interest for use in soils is their ability to store water. For this reason, it has already been proposed several times to use hydrogels in arid or semi-arid areas too. Fields of use include the cultivation of useful plants, but also areas of lawn, especially golf courses.

In a multitude of these applications, however, it has been found that the amount of water used is still too high in spite of use of hydrogels.

It is therefore an object of the invention to provide an irrigation method and system for hydrogel-containing soils in which the input of the amount of water used can still be optimized.

This object is achieved by a method according to claim 1. According to this, a method is proposed for irrigating hydrogel-containing soils, which comprises irrigating with an amount of water per square meter of ≧0.5 l/m² and ≦15 l/m² at a rate of from ≧20 to ≧50 l/h where irrigation is required.

In many applications within the present invention, by virtue of the amount of irrigation per square meter being limited, such a method can prevent water from penetrating into deeper soil layers and being lost for the intended use, which would otherwise be the case in the presence of hydrogels in the soil.

The expression “hydrogel-containing” in the context of the present invention means or embraces especially the incorporation of hydrogels into the soil before planting.

The expression “hydrogel” in the context of the present invention means or embraces especially water-comprising or non-water-comprising but water-insoluble polymers whose molecules are linked chemically, for example by means of covalent or ionic bonds, or physically, for example by means of interlooping of the polymer chains, to give a three-dimensional network, and which are capable of swelling with increase in volume when water or aqueous solutions are added.

An advantageous embodiment of the present method which is preferred in this respect comprises irrigation with an amount of water per square meter of ≧1 l/m² and ≦9 l/m², more preferably ≧5 l/m² and ≦8 l/m², where irrigation is required. This has been found to be advantageous in many embodiments of the present invention.

An advantageous embodiment of the present method which is preferred in this respect is that irrigation is effected at a rate of from ≧30 to ≦40 l/h where irrigation is required.

Furthermore, the object is achieved by a method according to claim 3. According to this, a method is proposed for irrigating hydrogel-containing soils, which comprises irrigating at a rate of from ≧20 to ≦50 l/h when a suction pressure of ≧200 mbar is present in the vicinity of the roots and/or a subsection in the range from ≧5 to ≦50 cm of soil depth.

The expression “suction pressure” in the context of the present invention embraces especially the water potential of the soil measured with customary potentiometers.

The expression “the vicinity of the roots” in the context of the present invention comprises especially the soil region penetrated by the roots of the plants growing above ground.

The expression “a subsection in the range from ≧5 to ≦50 cm of soil depth” includes or embraces especially at least one selected point within the range from ≧5 to ≦50 cm of soil depth at which the suction pressure is measured.

In many applications within the present invention, by virtue of irrigation only at a minimum suction pressure, such a method can ensure that the plants which are cultivated in the hydrogel-containing soil utilize the water optimally and thus no water is wasted.

In a preferred embodiment of the present invention, irrigation is effected when a suction pressure of ≧500 mbar, preferably ≧800 mbar, is present in the vicinity of the roots and/or a subsection in the range of from ≧5 to ≦50 cm of soil depth. This has been found to be advantageous for many applications within the present invention, since the absorption capacity of the plants for the water is thus increased once again.

An advantageous embodiment of the present method which is preferred in this respect comprises ending irrigation when the suction pressure falls below ≦50 mbar. This has been found to be advantageous for many applications within the present invention since the water supply is thus often optimal and water does not pass unnecessarily into the deeper soil layers.

An advantageous embodiment of the present method which is preferred in this respect comprises irrigating at a rate of from ≧30 to ≦40 l/h where irrigation is required.

An advantageous embodiment of the present method which is preferred in this respect comprises measuring the suction pressure continuously or at intervals of ≧5 s and ≦10 min, preferably ≧1 min and ≦5 min.

An advantageous embodiment of the present method which is preferred in this respect comprises performing irrigation when the suction pressure in the vicinity of the roots is ≧50 mbar and ≦200 mbar, and ending the irrigation when the suction pressure is outside these limits. This has been found to be advantageous for many applications within the present invention, since the water supply can thus often be optimized further.

An advantageous embodiment of the present method which is preferred in this respect comprises performing irrigation when the suction pressure in the vicinity of the roots is ≧50 mbar and ≦500 mbar, more preferably ≦800 mbar, and ending the irrigation when the suction pressure is outside these limits.

An advantageous embodiment of the present method which is preferred in this respect comprises irrigating with an amount of water per square meter of ≧0.5 l/m² and ≦15 l/m², preferably ≧1 l/m² and ≦9 l/m², more preferably ≧5 l/m² and ≦8 l/m².

An advantageous embodiment of the present method which is preferred in this respect comprises using sprinklers and/or droplet irrigation.

The present invention also relates to an irrigation system for a method according to the invention.

In a preferred embodiment of the present invention, the hydrogel content in % by weight is from ≧0.05% to ≦1% of the dry soil.

In a preferred embodiment of the present invention, ≧90% of the hydrogel is present in a soil depth of from ≧5 to ≦50 cm.

In a preferred embodiment of the present invention, the soil comprises at least one superabsorbent hydrogel, preferably in at least partly swollen form. “Superabsorbent hydrogel” (also referred to hereinafter simply as “superabsorbent”) in the context of the present invention is also understood to mean especially materials for which terms such as “highly swellable polymer”, “hydrogel” (often also used for the dry form), “hydrogel-forming polymer”, “water-absorbing polymer”, “absorbing gel-forming material”, “swellable resin”, “water-absorbing resin” or the like are also commonly used.

Furthermore, “superabsorbent hydrogel” (also referred to hereinafter simply as “superabsorbent”) in the context of the present invention is understood to mean crosslinked hydrophilic polymers, especially polymers of (co)polymerized hydrophilic monomers, graft (co)polymers of one or more hydrophilic monomers on a suitable graft base, crosslinked cellulose ethers or starch ethers, crosslinked carboxymethyl-cellulose, partly crosslinked polyalkylene oxide or natural products swellable in aqueous liquids, for example guar derivatives.

The at least one superabsorbent preferably has a swellability in distilled water of at least ≧80 g/g, preferably at least ≧120 g/g and more preferably at least ≧180 g/g, and a CRC (“centrifuge retention capacity”) of at least ≧40 g/g, preferably at least ≧80 g/g and more preferably at least ≧100 g/g.

The at least one superabsorbent is preferably obtained by polymerizing a monomer solution comprising
a) at least one ethylenically unsaturated monomer bearing acid groups,
b) at least one crosslinker,
c) optionally one or more ethylenically and/or allylically unsaturated monomers copolymerizable with the monomer a) and
d) optionally one or more water-soluble polymers onto which monomers a), b) and, if appropriate, c) can be grafted at least partly.

Suitable monomers a) are, for example, ethylenically unsaturated carboxylic acids such as acrylic acid, methacrylic acid, maleic acid, fumaric acid and itaconic acid, or derivatives thereof, such as acrylamide, methacrylamide, acrylic esters and methacrylic esters. Particularly preferred monomers are acrylic acid and methacrylic acid. Very particular preference is given to acrylic acid.

The monomers a), especially acrylic acid, comprise preferably up to 0.025% by weight of a hydroquinone monoether. Preferred hydroquinone monoethers are hydroquinone monomethyl ether (MEHQ) and/or tocopherols.

Tocopherol is understood to mean especially compounds of the following formula

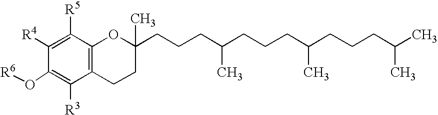

where R³ is hydrogen or methyl, R⁴ is hydrogen or methyl, R⁵ is hydrogen or methyl, and R⁴ is hydrogen or an acyl radical having from 1 to 20 carbon atoms.

Preferred radicals for R⁶ are acetyl, ascorbyl, succinyl, nicotinyl and other physiologically compatible carboxylic acids. The carboxylic acids may be mono-, di- or tricarboxylic acids.

Preference is given to alpha-tocopherol where R³═R⁴═R⁵=methyl, in particular racemic alpha-tocopherol. R⁶ is more preferably hydrogen or acetyl. RRR-alpha-tocopherol is especially preferred.

The monomer solution comprises preferably at most 130 ppm by weight, more preferably at most 70 ppm by weight, preferably at least 10 ppm by weight, more preferably at least 30 ppm by weight, in particular around 50 ppm by weight, of hydroquinone monoether, based in each case on acrylic acid, acrylic acid salts also being considered as acrylic acid. For example, the monomer solution can be prepared by using acrylic acid having an appropriate content of hydroquinone monoether.

The crosslinkers b) are compounds having at least two polymerizable groups which can be polymerized by a free-radical mechanism into the polymer network. Suitable crosslinkers b) are, for example, ethylene glycol dimethacrylate, diethylene glycol diacrylate, allyl methacrylate, trimethylolpropane triacrylate, triallylamine, tetraallyloxyethane, di- and triacrylates, mixed acrylates which, as well as acrylate groups, comprise further ethylenically unsaturated groups, or crosslinker mixtures.

Suitable crosslinkers b) are in particular N,N′-methylenebisacrylamide and N,N′-methylenebismethacrylamide, esters of unsaturated mono- or polycarboxylic acids of polyols, such as diacrylate or triacrylate, for example butanediol diacrylate, butanediol dimethacrylate, ethylene glycol diacrylate or ethylene glycol dimeth-acrylate, and also trimethylolpropane triacrylate and allyl compounds such as allyl(meth)acrylate, triallyl cyanurate, diallyl maleate, polyallyl esters, tetraallyloxyethane, triallylamine, tetraallylethylenediamine, allyl esters of phosphoric acid and vinylphosphonic acid derivatives, as described, for example, in EP 343 427 A2. Further suitable crosslinkers b) are pentaerythritol diallyl ether, pentaerythritol triallyl ether and pentaerythritol tetraallyl ether, polyethylene glycol diallyl ether, ethylene glycol diallyl ether, glycerol diallyl ether and glycerol triallyl ether, polyallyl ethers based on sorbitol, and ethoxylated variants thereof. In the method according to the invention, it is possible to use di(meth)acrylates of polyethylene glycols, the polyethylene glycol used having a molecular weight between 300 and 1000.

However, particularly advantageous crosslinkers b) are di- and triacrylates of 3- to 15-tuply ethoxylated glycerol, of 3- to 15-tuply ethoxylated trimethylolpropane, of 3- to 15-tuply ethoxylated trimethylolethane, in particular di- and triacrylates of 2- to 6-tuply ethoxylated glycerol or of 2- to 6-tuply ethoxylated trimethylolpropane, of 3-tuply propoxylated glycerol or of 3-tuply propoxylated trimethylolpropane, and also of 3-tuply mixed ethoxylated or propoxylated glycerol or of 3-tuply mixed ethoxylated or propoxylated trimethylolpropane, of 15-tuply ethoxylated glycerol or of 15-tuply ethoxylated trimethylolpropane, and also of 40-tuply ethoxylated glycerol, of 40-tuply ethoxylated trimethylolethane or of 40-tuply ethoxylated trimethylolpropane.

Very particularly preferred crosslinkers b) are the polyethoxylated and/or -propoxylated glycerols which have been esterified with acrylic acid or methacrylic acid to give di- or triacrylates. Di- and/or triacrylates of 3- to 10-tuply ethoxylated glycerol are particularly advantageous. Very particular preference is given to di- or triacrylates of 1- to 5-tuply ethoxylated and/or propoxylated glycerol. Most preferred are the triacrylates of 3- to 5-tuply ethoxylated and/or propoxylated glycerol. These feature particularly low residual contents (typically below 10 ppm by weight) in the water-absorbing polymer, and the aqueous extracts of the water-absorbing polymers thus produced have an almost unchanged surface tension (typically at least 0.068 N/m) in comparison to water at the same temperature.

Ethylenically unsaturated monomers c) copolymerizable with the monomers a) are, for example, acrylamide, methacrylamide, crotonamide, dimethylaminoethyl methacrylate, dimethylaminoethyl acrylate, dimethylaminopropyl acrylate, diethylaminopropyl acrylate, dimethylaminobutyl acrylate, dimethylaminoethyl methacrylate, diethylaminoethyl methacrylate, dimethylaminoneopentyl acrylate and dimethylaminoneopentyl methacrylate.

The water-soluble polymers d) used may be polyvinyl alcohol, polyvinylpyrrolidone, starch, starch derivatives, polyglycols, polymers formed in a formal sense completely or partly from vinylamine monomers, such as partly or fully hydrolyzed polyvinylamide (so-called “polyvinylamine”) or polyacrylic acids, preferably polyvinyl alcohol and starch.

The polymerization is optionally performed in the presence of customary polymerization regulators. Suitable polymerization regulators are, for example, thio compounds, such as thioglycolic acid, mercapto alcohols, e.g. 2-mercaptoethanol, mercaptopropanol and mercaptobutanol, dodecyl mercaptan, formic acid, ammonia and amines, for example ethanolamine, diethanolamine, triethanolamine, triethylamine, morpholine and piperidine.

The monomers (a), (b) and if appropriate (c) are, optionally in the presence of the water-soluble polymers d), (co)polymerized with one another in the presence of polymerization initiators in from 20 to 80% by weight, preferably from 20 to 50% by weight, especially from 30 to 45% by weight aqueous solution. The polymerization initiators used may be all compounds which decompose to free radicals under the polymerization conditions, for example peroxides, hydroperoxides, hydrogen peroxide, persulfates, azo compounds and the so-called redox initiators. Preference is given to the use of water-soluble initiators. In some cases, it is advantageous to use mixtures of different polymerization initiators, for example mixtures of hydrogen peroxide and sodium peroxodisulfate or potassium peroxodisulfate. Mixtures of hydrogen peroxide and sodium peroxodisulfate can be used in any desired ratio. Suitable organic peroxides are, for example, acetylacetone peroxide, methyl ethyl ketone peroxide, tert-butyl hydroperoxide, cumene hydroperoxide, tert-amyl perpivalate, tert-butyl perpivalate, tert-butyl perneohexanoate, tert-butyl perisobutyrate, tert-butyl per-2-ethylhexanoate, tert-butyl perisononanoate, tert-butyl permaleate, tert-butyl perbenzoate, tert-butyl per-3,5,5-trimethylhexanoate and tert-amyl perneodecanoate. Further suitable polymerization initiators are azo initiators, for example 2,2′-azobis(2-amidinopropane) dihydrochloride, 2,2′-azobis(N,N-di-methylene)isobutyramidine dihydrochloride, 2-(carbamoylazo)isobutyronitrile and 4,4′-azobis(4-cyanovaleric acid). The polymerization initiators mentioned are used in customary amounts, for example in amounts of from 0.01 to 5 mol %, preferably from 0.1 to 2 mol %, based on the monomers to be polymerized.

The redox initiators comprise, as an oxidizing component, at least one of the above-specified per compounds and a reducing component, for example ascorbic acid, glucose, sorbose, ammonium hydrogen sulfite, ammonium sulfite, ammonium thiosulfate, ammonium hyposulfite, ammonium pyrosulfite, ammonium sulfide, alkali metal hydrogen sulfite, alkali metal sulfite, alkali metal thiosulfate, alkali metal hyposulfite, alkali metal pyrosulfite or alkali metal sulfide, metal salts such as iron(II) ions or silver ions, or sodium hydroxymethylsulfoxylate. Preference is given to using, as a reducing component of the redox initiator, ascorbic acid or sodium pyrosulfite. Based on the amount of monomers used in the polymerization, from 1·10⁻⁵ to 1 mol % of the reducing component of the redox initiator and from 1·10⁻⁵ to 5 mol % of the oxidizing component are used. Instead of the oxidizing component or in addition, it is also possible to use one or more water-soluble azo initiators.

Preference is given to using a redox initiator consisting of hydrogen peroxide, sodium peroxodisulfate and ascorbic acid. For example, these components are used in the concentrations of 1·10⁻² mol % of hydrogen peroxide, 0.084 mol % of sodium peroxodisulfate and 2.5·10⁻³ mol % of ascorbic acid, based on the monomers.

The aqueous monomer solution may comprise the initiator in dissolved or dispersed form. However, the initiators can also be fed to the polymerization reactor separately from the monomer solution.

For optimal action, the preferred polymerization inhibitors require dissolved oxygen. Therefore, the polymerization inhibitors can be freed of dissolved oxygen before the polymerization by inertization, i.e. flowing an inert gas through, preferably nitrogen. This is done by means of inert gas which can be introduced in cocurrent, countercurrent or intermediate angles of entry. Good mixing can be achieved, for example, with nozzles, static or dynamic mixers or bubble columns. The oxygen content of the monomer solution before the polymerization is preferably lowered to less than 1 ppm by weight, more preferably to less than 0.5 ppm by weight. The monomer solution is optionally conducted through the reactor with an inert gas stream.

The at least one superabsorbent is preferably obtained by polymerizing an aqueous monomer solution and optionally a subsequent comminution of the hydrogel. Suitable preparation processes are, for example:
Gel polymerization in a batch process or tubular reactor and subsequent comminution in a meat grinder, extruder or kneader.
Polymerization in a kneader, in which case continuous comminution is effected by means of, for example, contrarotatory stirrer shafts.
Polymerization on a belt and subsequent comminution in a meat grinder, extruder or kneader.
Emulsion polymerization, which already provides bead polymers of relatively narrow gel size distribution.
In situ polymerization of a fabric layer which, usually in continuous operation, has been sprayed beforehand with aqueous monomer solution and then subjected to a photopolymerization.

The reaction is preferably performed in a kneader or on a belt reactor.

A process which is especially preferred in the context of this invention is continuous gel polymerization. In this process, a monomer mixture is first prepared by adding the neutralizing agent, optional comonomers and/or further assistants separately and sequentially in terms of space and/or time to the acrylic acid solution, and then transferring the mixture to the reactor, or actually initially charging it in the reactor. As the last addition, the initiator system is metered in at the start of the polymerization. In the subsequent continuous polymerization process, the reaction proceeds to give the polymer gel (i.e. the polymer swollen to a gel in the solvent of the polymerization—typically water), which, in the case of a stirred polymerization, is already comminuted in advance. The polymer gel is subsequently dried, if required, also crushed, ground and screened, and transferred to further surface treatment.

The acid groups of the resulting hydrogels are typically partly neutralized, generally to an extent of at least ≧25 mol %, preferably to an extent of at least ≧27 mol % and more preferably at least ≧40 mol %, and generally at most ≦85 mol %, preferably at most ≦80 mol % and more preferably at most ≦75 mol %, for which the customary neutralizing agents can be used, preferably alkali metal hydroxides, alkali metal oxides, alkali metal carbonates or alkali metal hydrogencarbonates, and mixtures thereof. Instead of alkali metal salts, it is also possible to use ammonium salts. Sodium and potassium are particularly preferred as alkali metals, but very particular preference is given to sodium hydroxide, sodium carbonate or sodium hydrogen-carbonate, and mixtures thereof. Typically, the neutralization is achieved by mixing the neutralizing agent in as an aqueous solution or preferably also as a solid. For example, sodium hydroxide with a water content significantly below ≦50% by weight may be present as a waxy material with a melting point above ≧23° C. In this case, metered addition as a piece material or melt at elevated temperature is possible.

The neutralization can be carried out after the polymerization at the hydrogel stage. However, it is also possible to carry out the neutralization to the desired degree of neutralization completely or partly before the polymerization. In the case of partial neutralization before the polymerization, generally at least ≧10 mol %, preferably at least ≧15 mol % and generally at most ≦40 mol %, preferably at most ≦30 mol % and more preferably at most ≦25 mol % of the acid groups in the monomers used are neutralized before the polymerization by adding a portion of the neutralizing agent actually to the monomer solution. The desired final degree of neutralization is not established in this case until toward the end or after the polymerization, preferably at the hydrogel stage before it is dried. The monomer solution is neutralized by mixing in the neutralizing agent. The hydrogel can be comminuted mechanically in the course of neutralization, for example by means of a meat grinder or comparable apparatus to comminute gel-like materials, in which case the neutralizing agent is sprayed in, scattered over or poured over and then carefully mixed in. To this end, the resulting gel material can be ground with a meat grinder several times more for homogenization.

The monomer solution is preferably adjusted to the desired final degree of neutralization by adding the neutralizing agent before polymerization.

The gels obtained from the polymerization are optionally kept at a temperature of generally at least ≧50° C. and preferably at least ≧70° C. and generally at most ≦130° C. and preferably at most ≦100° C. for a certain time, for example at least ≧30 minutes, preferably at least ≧60 minutes and more preferably at least ≧90 minutes, and generally at most ≦12 hours, preferably at most ≦8 hours and more preferably at most ≦6 hours, which often improves their properties further.

The neutralized hydrogel is then dried with a belt drier or roll drier until the residual moisture content is preferably below ≦15% by weight, especially below ≦10% by weight, the water content being determined by the EDANA (European Disposables and Nonwovens Association) test method no. 432.2-02 “Moisture Content”. The dry superabsorbent consequently comprises up to ≦15% by weight of moisture, preferably at most ≦10% by weight. The crucial factor for classification as “dry” is sufficient free flow, especially for handling as a powder (for instance for pneumatic delivery, filling, screening or other process steps from solids process technology). Optionally, it is also possible to use a fluidized-bed drier or a heated plowshare mixer for drying. In order to obtain particularly colorless products, it is advantageous to ensure that the evaporating water is removed rapidly in the course of drying of this gel. To this end, the drier temperature has to be optimized, the air supply and removal have to be controlled, and sufficient venting has to be ensured in each case. By its nature, the higher the solids content of the gel, the simpler the drying and the more colorless the product. The solvent content in the polymerization is therefore adjusted such that the solids content of the gel before the drying is therefore generally at least ≧20% by weight, preferably at least ≧25% by weight and more preferably at least ≧30% by weight, and generally at most ≦90% by weight, preferably at most ≦85% by weight and more preferably at most ≦80% by weight. It is particularly advantageous to vent the drier with nitrogen or another nonoxidizing inert gas. Optionally, though, it is also possible simply only to lower the partial pressure of the oxygen during the drying, in order to prevent oxidative yellowing processes. In general, though, sufficient venting and removal of the water vapor also leads to a still acceptable product. In general, a very short drying time is advantageous in terms of color and product quality.

The dried hydrogel (which is no longer a gel (even though it is still often referred to as such) but rather a dry polymer with superabsorbent properties, which falls under the term “superabsorbent”) is preferably ground and screened, and the apparatus used for grinding may typically be roll mills, pin mills, hammer mills, cutting mills or vibratory mills. The particle size of the screened dry hydrogel is preferably below ≦1000 μm, more preferably below ≦900 μm, even more preferably below ≦850 μm, and preferably more than ≧800 μm, more preferably more than ≧90 μm, most preferably more than ≧100 μm.

Very particular preference is given to a particle size (screening section) of from ≧106 to ≦850 μm. The particle size is determined by the EDANA (European Disposables and Nonwovens Association) test method no. 420.2-02 “Particle size distribution”.

The dry superabsorbent polymers thus prepared are typically referred to as “base polymers” and are preferably subsequently surface postcrosslinked. The surface postcrosslinking can be done in a manner known per se with dried, ground and screened-off polymer particles. To this end, compounds which can react with the functional groups of the base polymer with crosslinking are usually applied in the form of a solution to the surface of the base polymer particles. Suitable postcrosslinking agents are, for example:
di- or polyepoxides, for instance di- or polyglycidyl compounds such as phosphonic acid diglycidyl ester, ethylene glycol diglycidyl ether or bischlorohydrin ethers of polyalkylene glycols,
alkoxysilyl compounds,
polyaziridines, compounds which comprise aziridine units and are based on polyethers or substituted hydrocarbons, for example bis-N-aziridinomethane,
polyamines or polyamidoamines and reaction products thereof with epichlorohydrin,
polyols such as ethylene glycol, 1,2-propanediol, 1,4-butanediol, glycerol, methyltriglycol, polyethylene glycols having a mean molecular weight Mw of 200-10 000, di- and polyglycerol, pentaerythritol, sorbitol, the oxyethylates of these polyols and the esters thereof with carboxylic acids or of carbonic acid, such as ethylene carbonate or propylene carbonate,
carbonic acid derivatives such as urea, thiourea, guanidine, dicyandiamide, 2-oxazolidinone and derivatives thereof, bisoxazoline, polyoxazolines, di- and polyisocyanates,
di- and poly-N-methylol compounds, for example methylenebis(N-methylol-methacrylamide) or melamine-formaldehyde resins,
compounds having two or more blocked isocyanate groups, for example trimethylhexamethylene diisocyanate blocked with 2,2,3,6-tetramethyl-piperidinone-4.

If required, acidic catalysts, for example p-toluenesulfonic acid, phosphoric acid, boric acid or ammonium dihydrogenphosphate, can be added.

Particularly suitable postcrosslinking agents are di- or polyglycidyl compounds such as ethylene glycol diglycidyl ether, the reaction products of polyamidoamines with epichlorohydrin, 2-oxazolidinone or N-hydroxyethyl-2-oxazolidinone.

The surface postcrosslinking (often also just “postcrosslinking”) is typically performed by spraying a solution of the surface postcrosslinker (often also just “postcrosslinker”) onto the hydrogel or the dry base polymer powder.

The solvent used for the surface postcrosslinker is a customary suitable solvent, for example water, alcohols, DMF, DMSO and mixtures thereof. Particular preference is given to water and water/alcohol mixtures, for example water/methanol, water/isopropanol, water/1,2-propanediol and water/1,3-propanediol.

The spraying-on of a solution of the postcrosslinker is preferably performed in mixers with moving mixing tools, such as screw mixers, paddle mixers, disk mixers, plowshare mixers and shovel mixers. Particular preference is given to vertical mixers, very particular preference to plowshare mixers and shovel mixers. Suitable and known mixers are, for example, Lödige®, Bepex®, Nauta®, Processall® and Schugi® mixers. Very particular preference is given to using high-speed mixers, for example of the Schugi-Flexomix® or Turbolizer® type.

The spraying-on of the crosslinker solution can optionally be followed by a thermal treatment step, essentially for performing the surface postcrosslinking reaction (nevertheless usually referred to just as “drying”), preferably in a downstream heated mixer (“drier”), at a temperature of generally at least ≧50° C., preferably at least ≧80° C. and more preferably at least ≧90° C. and generally at most ≦250° C., preferably at most ≦200° C. and more preferably at most ≦150° C. The mean residence time (i.e. the average residence time of the individual superabsorbent particles) of the superabsorbent to be treated in the drier is generally at least ≧1 minute, preferably at least ≧3 minutes and more preferably at least ≧5 minutes, and generally at most ≦6 hours, preferably at most ≦2 hours and more preferably at most ≦1 hour. In addition to the actual drying, both any cleavage products present and solvent fractions are removed. The thermal drying is performed in customary driers such as tray driers, rotary tube ovens or heatable screws, preferably in contact driers. Preference is given to the use of driers in which the product is moved, i.e. heated mixers, more preferably shovel driers, most preferably disk driers. Suitable driers are, for example, Bepex® driers and Nara® driers. Moreover, it is also possible to use fluidized bed driers. However, the drying can also be effected in the mixer itself, by heating the jacket or by blowing in a preheated gas such as air. However, it is also possible, for example, to utilize an azeotropic distillation as the drying process. The crosslinking reaction can take place either before or during the drying.

In a particularly preferred embodiment of the invention, the hydrophilicity of the particle surface of the base polymers is additionally modified by forming complexes. Complexes are formed on the outer shell of the particles by spraying on solutions of di- or polyvalent cations, in which case the cations can react with the acid groups of the polymer to form complexes. Examples of di- or polyvalent cations are polymers derived in a formal sense completely or partly from vinylamine monomers, such as partly or fully hydrolyzed polyvinylamide (so-called “polyvinylamine”), whose amine groups are always present—even at very high pH—partly in protonated form to give ammonium groups, or metal cations such as Mg²⁺, Ca²⁺, Al³⁺, Sc³⁺, Ti⁴⁺, Mn²⁺, Fe^{2+/3+}, Co²⁺, Ni²⁺, Cu²⁺, Zn²⁺, Y³⁺, Zr⁴⁺, La³⁺, Ce⁴⁺, Hf⁴⁺, and Au³⁺. Preferred metal cations are Mg²⁺, Ca²⁺, Al³⁺, Ti⁴⁺, Zr⁴⁺ and La³⁺, and particularly preferred metal cations are Al³⁺, Ti⁴⁺ and Zr⁴⁺. The metal cations may be used either alone or in a mixture with one another. Among the metal cations mentioned, all metal salts which have a sufficient solubility in the solvent to be used are suitable. Particularly suitable metal salts are those with weakly complexing anions, for example chloride, nitrate and sulfate, hydrogensulfate, carbonate, hydrogencarbonate, nitrate, phosphate, hydrogenphosphate, dihydrogenphosphate and carboxylate, such as acetate and lactate. Particular preference is given to using aluminum sulfate. The solvents used for the metal salts may be water, alcohols, DMF, DMSO and mixtures of these components. Particular preference is given to water and water/alcohol mixtures, for example water/methanol, water/isopropanol, water/1,2-propanediol and water/1,3-propanediol.

The base polymer is treated with a solution of a di- or polyvalent cation in the same manner as with the surface postcrosslinker, including the optional drying step. Surface postcrosslinker and polyvalent cation can be sprayed on in a combined solution or as separate solutions. The metal salt solution can be sprayed onto the superabsorbent particles either before or after the surface postcrosslinking. In a particularly preferred process, the metal salt solution is sprayed on in the same step as the spraying-on of the crosslinker solution, in which case the two solutions are sprayed on separately and in succession or simultaneously via two nozzles, or crosslinker and metal salt solution can be sprayed on combined through one nozzle.

When a drying step is performed after the surface postcrosslinking and/or treatment with complexing agent, it is advantageous but not absolutely necessary to cool the product after the drying. The cooling can be effected continuously or batchwise; conveniently, the product is conveyed continuously into a cooler connected downstream of the drier. To this end, any apparatus known for removing heat from pulverulent solids can be used, especially any apparatus mentioned above as a drying apparatus, except that it is not charged with a heating medium but rather with a cooling medium, for example with cooling water, such that heat is not introduced into the superabsorbent via the walls and, according to the construction, also via the stirrer units or other heat exchange surfaces, but rather removed therefrom. Preference is given to the use of coolers in which the product is moved, i.e. cooled mixers, for example shovel coolers, disk coolers or paddle coolers, for instance in Nara® or Bepex® coolers. The superabsorbent can also be cooled in a fluidized bed by blowing in a cooled gas such as cold air. The conditions of the cooling are adjusted such that a superabsorbent with the temperature desired for the further processing is obtained. Typically, a mean residence time in the cooler of generally at least ≧1 minute, preferably at least ≧3 minutes and more preferably at least ≧5 minutes, and generally at most ≦6 hours, preferably at most ≦2 hours and more preferably at most ≦1 hour, is established, and the cooling output is such that the resulting product has a temperature of generally at least ≧0° C., preferably at least ≧10° C. and more preferably at least ≧20° C., and generally at most ≦100° C., preferably at most ≦80° C. and more preferably at most ≦60° C.

Optionally, yet a further modification of the superabsorbents can be effected by admixing fine inorganic solids, for example silicon dioxide, aluminum oxide, titanium dioxide and iron(II) oxide, which enhances the effects of the surface aftertreatment even further. Particular preference is given to the admixing of hydrophilic silicon dioxide or of aluminum oxide having a mean size of the primary particles of from ≧4 to ≦50 nm and a specific surface area of ≧50-≦450 m²/g. The admixing of fine inorganic solids is preferably effected after the surface modification by crosslinking/complex formation, but can also be effected before or during these surface modifications.

Optionally, the superabsorbent is provided with further customary additives and assistants which influence storage and handling properties. Examples thereof are dyes, opaque additives in order to improve the visibility of swollen gel, which is desirable in some applications, additives for improving the flow behavior of the powder, surfactants or the like. Often, antidusting or dust-binding agents are added to the superabsorbent. Antidusting or dust-binding agents are known; for example, polyether glycols such as polyethylene glycol having a molecular weight of from ≧400 to ≦20 000 g/mol, polyols such as glycerol, sorbitol, neopentyl glycol or trimethylolpropane, which are optionally also ≧7- to ≦20-tuply ethoxylated, are used. A finite water content of the superabsorbent can also be established by adding water if desired.

The solids, additives and assistants can each be added in separate process steps, but the most convenient method is usually to add them to the superabsorbent in the cooler, for instance by spraying on a solution or adding them in finely divided solid or liquid form.

The surface postcrosslinked superabsorbent is optionally ground and/or screened in a customary manner. Grinding is typically not required here, but the screening-off of agglomerates or fines formed is usually appropriate to establish the desired particle size distribution. Agglomerates and fines are either discarded or preferably recycled into the process in a known manner and at a suitable point; agglomerates after comminution. The particle size of the superabsorbent particles is preferably at most ≦1000 μm, more preferably at most ≦900 μm, even more preferably at most ≦850 μm, and preferably at least ≧80 μm, more preferably at least ≧90 μm, even more preferably at least ≧100 μm. Typical screening cuts are, for example, from ≧106 to 850 μm or from ≧150 to ≦850 μm.

The present invention also relates to the use of the method according to the invention and/or of an irrigation system for
useful plant cultivation
lawns
golf courses
vegetable cultivation
cotton plantations.

The shape, configuration, material selection and technical design of the aforementioned components and those to be used in accordance with the invention, which are claimed and described in the working examples, are not subject to any particular exceptional conditions, such that the selection criteria known in the application field can be applied without restriction.

Further details, features and advantages of the subject matter of the invention are evident from the subclaims and from the description of the accompanying examples which follows, and drawings in which the problems solved here and the inventive irrigation are illustrated. The drawings which relate to the examples show:

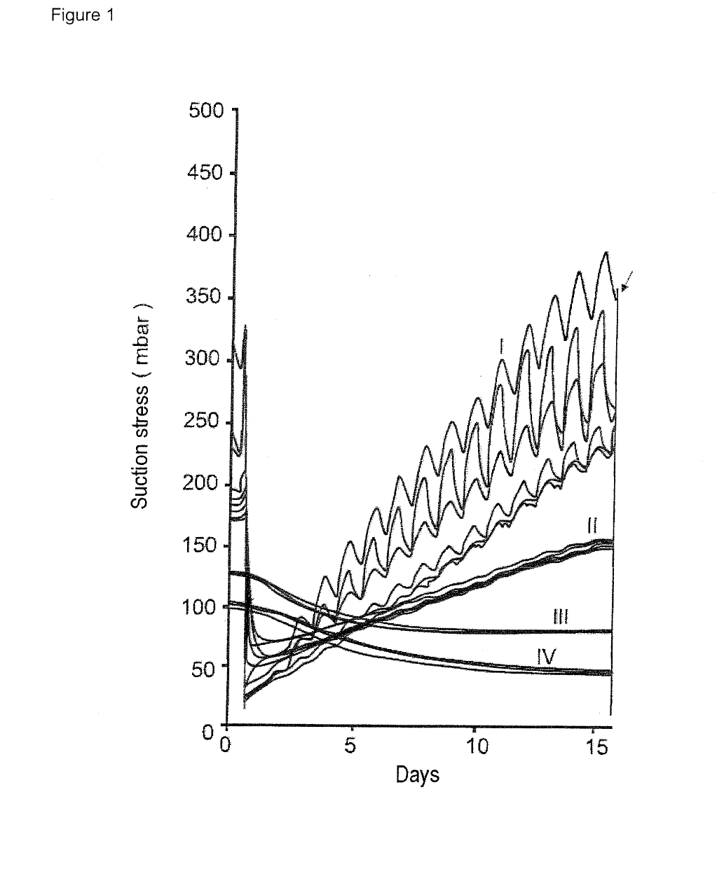

FIG. 1 an example of the water distribution in an irrigation as is customary today;

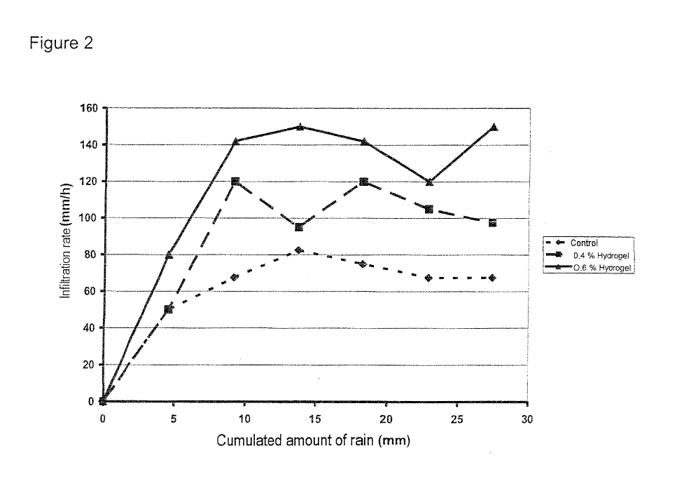

FIG. 2 a diagram of the cumulated amount of rain (in mm) against the infiltration rate in mm/h for three different hydrogel concentrations;

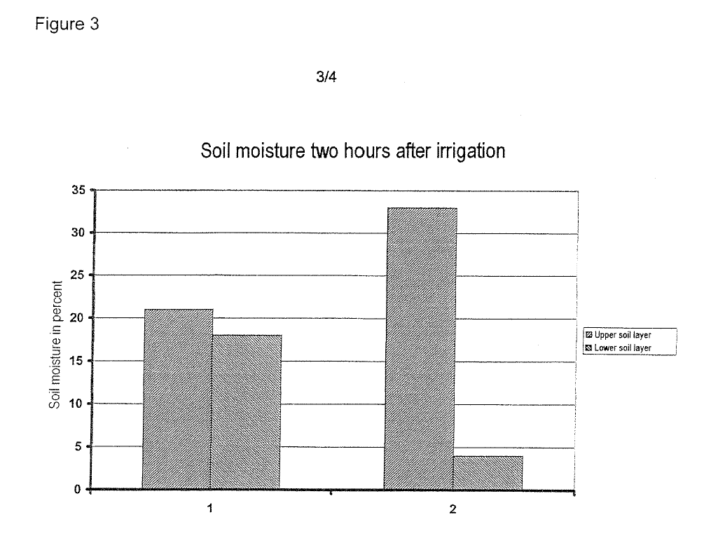

FIG. 3 a diagram of the water content for a hydrogel-containing test soil once with irrigation according to one embodiment of the method according to the invention and once in a control experiment; and

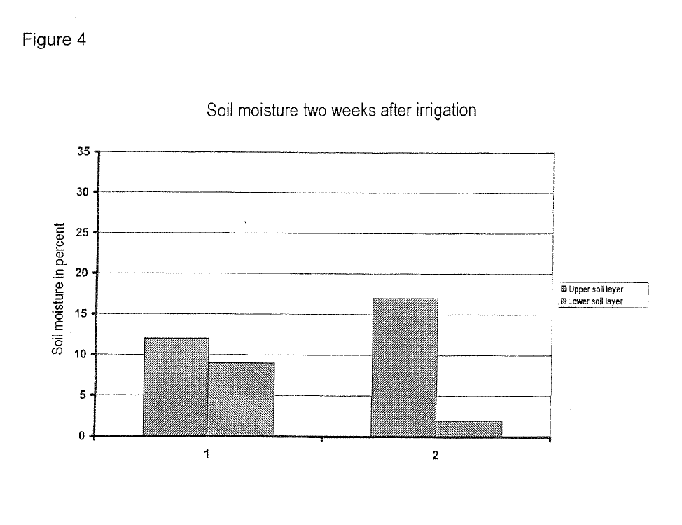

FIG. 4 a diagram of the water content for a hydrogel-containing test soil two weeks after irrigation, once with irrigation according to one embodiment of the method according to the invention and once in a control experiment.

FIG. 1 shows the distribution of the water in the soil after irrigation as is customary today.

A tree—Ilex europaeus—has been planted in a container which has been filled with humus-rich brown earth (FIG. 1). Tensiometers which measure the water content of the soil at soil depths 20 cm (I), 60 cm (II), 110 cm (III) and 150 cm (IV) have been introduced into this soil body. The water contents are measured as negative water potentials; the higher the absolute measured value of the water potentials, the lower is the water content in the soil. The curves show water distribution according to an irrigation customary today in horticultural practice:

The water potentials measured at soil depths 110 and 150 cm fall significantly after the irrigation and also remain at this low value after the tree has released the water present in the upper soil layers through the leaves into the air (curves of the water potentials at soil depths 20 and 60 cm). This fact shows clearly that, in the case of customary irrigation as is currently state of the art, a considerable portion of the water applied is transferred into lower soil layers and is thus no longer available to the plants.

FIG. 2 shows a diagram of the cumulated amount of rain (in mm) against the infiltration rate in mm/h for three different hydrogel concentrations.

The underlying experiment was performed in a customary rain simulator (Volcani model). The soil was introduced into a box of height 10 cm which was open at the top and had a funnel sieve at the bottom. In the case of rain, the water penetrating into the soil ran off at the bottom and was measured. Since the box had an inclination, the water which did not penetrate into the soil ran off at the top and was collected separately.

The following experiments were performed:

1. A test soil which did not contain any hydrogel was introduced.

2. The test soil was admixed with 0.4% hydrogel.

3. The test soil was admixed with 0.6% hydrogel.

The amount of rain applied in each case was identical in all experiments.

As FIG. 2 shows, the lowest infiltration rate was measured in the hydrogel-free soil; significantly more water penetrated into the hydrogel-containing soils. This shows that even the addition of hydrogel into the upper soil layers not only does not prevent the process of infiltration of the water into lower soil layers as shown in FIG. 2, which is undesired in the case of customary irrigation, but—completely surprisingly—even promotes it by increasing the infiltration rate.

FIG. 3 shows that, in an inventive irrigation, the water does not penetrate into the lower root-free soil layers.

A 20 cm-thick layer of dry test soil (water content: 3%) was introduced into four cylinders of diameter 30 cm, which were covered at the top by a sieve plate having a mesh size of 1 mm. A further 20 cm-thick layer of test soil, to which 0.4% hydrogel had been added, was placed onto this sieve plate.

Subsequently, cylinder 1a and 1b were irrigated with 6 liters of water using a watering can as usual in a plant nursery; the application time was about one minute; the can was equipped with a customary sprinkling attachment. This corresponds to an application rate of 360 l per hour.

The 6 liters of water were sprayed onto the upper soil layer in cylinders 2a and 2b within 10 minutes, and the droplet size was considerably smaller than in the case of a watering can used customarily in a plant nursery. This corresponds to an application rate of 36 l per hour.

After 2 hours, the soils separated from one another by the sieve plate in cylinders 1a and 2a were removed, and the water content therein was determined. The water content is reported in FIG. 3 (1=cylinder 1a, control, 2=cylinder 2a, inventive irrigation).

FIG. 3 shows that, in the case of rapid irrigation, almost half of the water has penetrated through into the lower soil layer, while, in the case of the slow irrigation by spraying, almost all water remained in the upper—hydrogel-containing—soil.

The two remaining cylinders comprising the irrigated soils were stored open at an average temperature of 30° C. in a greenhouse without humidity regulation for two weeks. Thereafter, the soils were separated again and the water contents were determined. The water content is shown in FIG. 3 (1=cylinder 1b, control, 2=cylinder 2b, inventive irrigation).

FIG. 4 shows that no equalization in the water contents has taken place between the soils with hydrogel addition and those without hydrogel. In all soils, the water content has decreased owing to the evaporation in the greenhouse, but the differences in the water contents measured directly after the irrigation were maintained.

Test Methods

Centrifuge Retention Capacity (“CRC”):

The centrifuge retention capacity (CRC) is determined by the EDANA (European Disposables and Nonwovens Association, Avenue Eugène Plasky 157, 1030 Brussels, Belgium) recommended test method No. 441.2-02 “Centrifuge Retention Capacity” which is obtainable from there.

1. A method for irrigating hydrogel-containing soils, which comprises irrigating with an amount of water per square meter of ≧0.5 l/m² and ≦15 l/m² at a rate of from ≧20 to ≦50 1/h where irrigation is required.

2. The method according to claim 1, wherein irrigation is effected with an amount of water per square meter of ≧1 l/m² and ≦9 l/m² where irrigation is required.

3. A method for irrigating hydrogel-containing soils, which comprises irrigating at a rate of from ≧20 to ≦50 l/h when a suction pressure of ≧200 mbar is present in the vicinity of the roots and/or a subsection in the range from ≧5 to ≦50 cm of soil depth.

4. The method according to claim 3, wherein the irrigation is ended when the suction pressure falls below ≦50 mbar.

5. The method according to claim 3, wherein the suction pressure is measured continuously or at intervals of ≧5 s and ≦10 min.

6. The method according to claim 3, wherein irrigation is performed when the suction pressure in the vicinity of the roots is ≧50 mbar and ≦200 mbar and irrigation is ended when the suction pressure is outside these limits.

7. The method according to claim 3, wherein irrigation is effected with an amount of water per square meter of ≧0.5 l/m² and ≦15 l/m².

8. The method according to claim 1, wherein sprinklers and/or droplet irrigation are used.

9. An irrigation system for a method according to claim 1.

10. The irrigation system according to claim 9, wherein the hydrogel content in % by weight is from ≧0.05% to ≦1% of the dry soil.

11. The irrigation system according to claim 9, wherein ≧90% of the hydrogel is present in a soil depth of from ≧5 to ≦50 cm.

12. The method according to claim 1 for
plant cultivations
lawns,
golf courses,
vegetable cultivation, or
cotton plantations.

13. The method according to claim 3, wherein sprinklers and/or droplet irrigation are used.

14. An irrigation system for a method according to claim 3.

15. The irrigation system according to claim 14 wherein the hydrogel content in % by weight is from ≧0.05% to ≦1% of the dry soil.

16. The irrigation system according to 14, wherein ≧90% of the hydrogel is present in a soil depth of from ≧5 to ≦50 cm.

17. An irrigation system according to claim 9 for plant cultivation, lawns, golf courses, vegetable cultivation, or cotton plantations.
